(19) United States
(12) Patent Application Publication
(10) Pub. No.: US 2019/0173939 A1
(43) Pub. Date: Jun. 6, 2019

(54) SHARING DATA LINKS WITH DEVICES BASED ON CONNECTION OF THE DEVICES TO A SAME LOCAL NETWORK

(71) Applicant: Google Inc., Mountain View, CA (US)

(72) Inventors: Justin Lewis, Marina del Rey, CA (US); Ruxandra Georgiana Paun, Santa Monica, CA (US)

(73) Assignee: Google Inc., Mountain View, CA (US)

(21) Appl. No.: 14/083,383

(22) Filed: Nov. 18, 2013

(51) Int. Cl. H04L 29/08

(52) U.S. Cl. CPC H04L 67/10

(57) ABSTRACT

Systems and methods are provided for sharing data links with devices based on connection of the devices to a same local network. In one or more aspects, a device includes a connection component configured to connect the device to a local intranet network and a sharing component configured to send a request to a remote content sharing server to share a link to a first content item, associated with a first remote content provider, with a second device connected to the local intranet network, wherein the request is based on connection of the device and the second device to the local intranet network and registration of the second device with the remote content sharing server.

### TECHNICAL FIELD

This application generally relates to systems and methods for sharing data links with devices based on connection of the devices to a same local network.

### BACKGROUND

Users frequently share links to content found via the Internet with other users. For example, users often share links to videos, images or articles found interesting or relevant on their social networking profiles or blogs with intent of having other users view or consume the shared data. Often times, a user may want to share a content item with people located around him at the time he discovers the content item. However, selecting a single medium that can effectuate a share to all users that are within close proximity to the sharing user can be difficult. For example, the sharing user would need to determine whether users within close proximity to the sharing user are respectively affiliated with a particular social network prior to employing the social network as a medium to effectuate the share. In another example, the sharing user would need to determine contact information for respective users within proximity to the sharing user prior to sharing the content item using electronic messages addressed to the targeted users.

### BRIEF DESCRIPTION OF THE DRAWINGS

Numerous aspects, embodiments, objects and advantages of the present invention will be apparent upon consideration of the following detailed description, taken in conjunction with the accompanying drawings, in which like reference characters refer to like parts throughout, and in which:

FIG. 1 illustrates an example system for sharing data links with devices based on connection of the devices to a same local network, in accordance with various aspects and embodiments described herein;

FIG. 2 presents an example client device that can be employed to share data links with devices based on connection of the devices to a same local network as the client device, in accordance with various aspects and embodiments described herein;

FIG. 3 presents an example user interface that facilitates authorizing registration of a client device with a remote local content sharing server in accordance with various aspects and embodiments described herein;

FIG. 4 presents an example user interface generated at a client device that that facilitates sharing information with devices based on connection of the devices to a same local network as the client device, in accordance with various aspects and embodiments described herein;

FIG. 5 presents an example user interface generated at a client device having a notification including information identifying a content item shared with the client device based on connection of the client device to a particular local area network, in accordance with various aspects and embodiments described herein;

FIG. 6 illustrates an example local content sharing server that facilitates sharing data links with devices based on connection of the devices to a same local network, in accordance with various aspects and embodiments described herein;

FIG. 7 illustrates another example of a local content sharing server that facilitates sharing data links with devices based on connection of the devices to a same local network, in accordance with various aspects and embodiments described herein;

FIG. 8 is a flow diagram of an example method for sharing data links with devices based on connection of the devices to a same local network, in accordance with various aspects and embodiments described herein;

FIG. 9 is a flow diagram of another example method for sharing data links with devices based on connection of the devices to a same local network, in accordance with various aspects and embodiments described herein;

FIG. 10 is a flow diagram of another example method for sharing data links with devices based on connection of the devices to a same local network, in accordance with various aspects and embodiments described herein;

FIG. 11 is a schematic block diagram illustrating a suitable operating environment in accordance with various aspects and embodiments.

FIG. 12 is a schematic block diagram of a sample-computing environment in accordance with various aspects and embodiments.

### DETAILED DESCRIPTION

The innovation is described with reference to the drawings, wherein like reference numerals are used to refer to like elements throughout. In the following description, for purposes of explanation, numerous specific details are set forth in order to provide a thorough understanding of this innovation. It may be evident, however, that the innovation can be practiced without these specific details. In other instances, well-known structures and components are shown in block diagram form in order to facilitate describing the innovation.

By way of introduction, the subject matter described in this disclosure relates to systems and methods for sharing information identifying a content item (e.g., a link or hyperlink) that is accessible via a network, with devices that are in proximity of one another based on connection of the devices to a same local network. In an aspect, devices connected to a local area network can become registered with a centralized server. Registration of a device with the centralized server can include associating the device with a local area network to which the device is currently connected. Registration of the device with the centralized server can also include providing authorization for the centralized server to send notifications to the device based on connection of the device the local area network.

In an aspect, in response to registration of a device with the centralized server, the device can send notifications targeted specifically for other devices connected to the same local network as the device. Similarly, the device can receive notifications from other devices targeted for the device based on its connection to the same local network as the other devices. According to this aspect, the notifications can include information identifying a content item, such as a link to the content item, shared with a device connected to a local area network from another device connected to the local area network based on connection of both devices to the local area network.

For example, when a user of a registered device wants to share a link to a video found on a video sharing website or cellular application, the user can select a sharing menu associated the website or application. One of the sharing menu options can include “share to people on my local area network.” When the user selects this sharing option, the user's device can send a request for the share to the centralized server. The request contains information identifying the video to be shared and information identifying the local area network the device is connected to. Upon receipt of the request by the centralized server, the centralized server can pull all the other devices which are currently registered as connected to the local area network, generate a notification for the other devices and send the notification to the other devices. The notification can include a link to the video (or information otherwise identifying the shared video). When one of the other devices receives the notification, a notification system associated with the receiving device or the video sharing website/application when accessed by the receiving device, can present the notification to the user. For example, where the receiving device is a smartphone, a graphical icon and associated text can be added to a notification menu displayed on an interface of the smartphone that indicates a link to a video provided by the video sharing website/application has been shared with the user.

In another aspect, in response to registration of a device with the centralized server as being connected to a local area network, the centralized server can push or send notifications to the device that are related to the device being connected to the local area network. For example, a coffee shop can employ the centralized server to send out coupons for the coffee shop to devices that connect to a local area network owned by the coffee shop. When a device connects to the local area network owned by the coffee shop, the centralized server can identify the device and send it the coupon. In some aspects, the coupons can include use restrictions related to the device being connected to the local area network for the coffee shop.

In one or more aspects, a device is provided that includes a connection component configured to connect the device to a local intranet network, and a sharing component configured to send a request to a remote content sharing server to share a link to a first content item, associated with a first remote content provider, with a second device connected to the local intranet network, wherein the request is based on connection of the device and the second device to the local intranet network and registration of the second device with the remote content sharing server.

In another aspect, a system is provided that includes a sharing component configured to receive a request from a first device, connected to a local area network, to share a content item accessible to the first device via a network, with other devices connected to the local area network. The system further includes an identification component configured to identify one or more other devices connected to the local area network, and a notification component configured to generate a notification message comprising information identifying the content item and send the notification message to the one or more other devices.

Further provided is a method that includes connecting, by a device including a processor, to a local area network and registering, by the device, with a remote content sharing server, comprising. The registering includes providing, by the device, information to the remote content sharing server identifying the device and the local area network. The method further includes receiving, by the device, a notification from the remote content sharing server based on the registering.

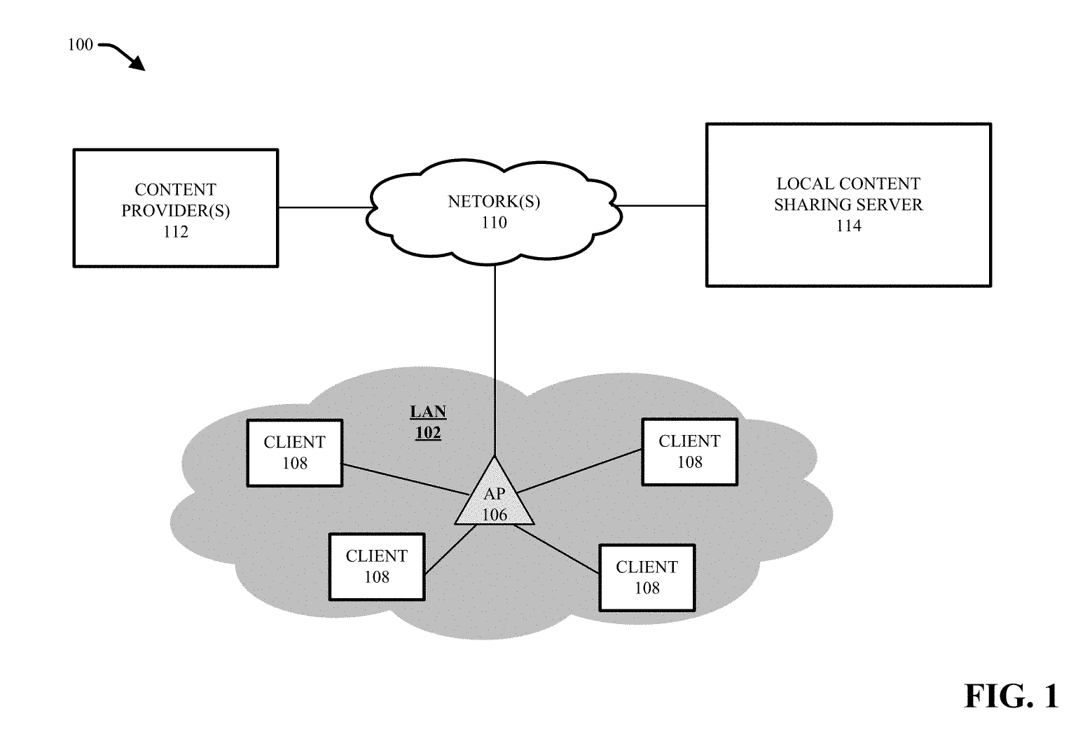

Referring now to the drawings, with reference initially to FIG. 1, presented is a diagram of an example system 100 for sharing information identifying content items accessible via a network with devices based on connection of the devices to a same local network, in accordance with various aspects and embodiments described herein. Aspects of systems, apparatuses or processes explained in this disclosure can constitute machine-executable components embodied within machine(s), e.g., embodied in one or more computer readable mediums (or media) associated with one or more machines. Such components, when executed by the one or more machines, e.g., computer(s), computing device(s), virtual machine(s), etc. can cause the machine(s) to perform the operations described.

System 100 includes one or more content provider(s) 112, a local content sharing server 114, and a plurality of client devices 108 connected to a local area network (LAN) 102. It should be appreciated that although four client devices 108 are presented in system 100 for exemplary purposes, system 100 can be employed in association with any suitable number N of client devices. Content provider(s) 112 and local content sharing server 114 are accessible to client devices 108 via one or more networks 110 (e.g., a wide area network (WAN)). In an aspect, client devices 108 connect to a network 110 via an access point device 106 (e.g., a wireless fidelity (WiFi) access point device) associated with the LAN 102. In some aspects, (although not depicted), client devices 108 can connect to network 110 via a plurality of access point devices associated with the LAN 102.

Local content sharing server 114 is configured to facilitate sharing information identifying a content item (e.g., a link or hyperlink) provided at a content provider 112 between client devices 108 based on connection of the respective devices to the same LAN (102). In an aspect, (not depicted) a content provider 112 can include local content sharing server 114 to facilitate sharing information provided by content provider 112 with client devices 108 based at least in part on the LAN to which the respective devices are connected.

A content provider 112 includes an entity configured to provide content or content items to a device (e.g., client device 108) via a network 110 (e.g., the Internet). As used herein, the term content item refers to any suitable data object that can be linked to and accessed or otherwise shared via a network 110 and includes but is not limited to: documents, articles, messages, media items, webpages, programs, and applications. In an aspect, a content item includes an item that has a uniform resource locator (URL). The term media content or media item can include but is not limited to video, live video, animations, video advertisements, music, music videos, sound files, pictures, and thumbnails. In some aspects, the term media content or media item includes a collection of media items such as a playlist including several videos or songs, or a channel including several videos or songs associated with a single media creator.

For example, content provider 112 can include a website or application configured to present pictures, articles, blogs, videos, or other types of content items to client devices 108 via a network 110. According to this example, the content provided on by the website or application can be configured for downloading, streaming or merely viewing at a client device via a network 110. In another example, a content provider 112 can include a networked source configured to provide digital coupons to devices 108 via a network.

In an exemplary embodiment, a content provider 112 includes a streaming media provider configured to provide streamed media to client devices 108 over network 110. The media can be stored in memory associated with the media provider and/or at various servers employed by media provider and accessed by client devices 108 using a website platform employed by the media provider or a cellular application employed by the media provider. For example, the media provider can provide and present media content to a user via a website that can be accessed by a client device 108 using a browser. In another example, the media provider can provide and present media to a user via a cellular application provided on a client device 108. In an aspect, the media provider can include a media presentation source that has access to a voluminous quantity (and potentially an inexhaustible number) of shared media (e.g., video and/or audio) files. The media presentation source can further stream these media files to one or more users at respective client devices 108 of the one or more users over network 110. In an aspect, the media provider can also receive media from one or more client devices 108 over a network 110.

A client device 108 can include any suitable computing device associated with a user and configured to connect to a LAN and wirelessly communicate with content provider 112 and/or or local content sharing server 114 via network 110. For example, client device 108 can include a desktop computer, a laptop computer, a television, an Internet television, a mobile phone, a smartphone, a tablet personal computer (PC), or a personal digital assistant (PDA). As used in this disclosure, the terms “content consumer” or “user” refer to a person, entity, system, or combination thereof that employs system 100 (or additional systems described in this disclosure) using client device 108. Network(s) 110 can include wired and wireless networks, including but not limited to, a WAN (e.g., the Internet) or a cellular network. A LAN is configured to connect one or more computing devices within close proximity to one another such as a home, school, laboratory or office building using network media. In an aspect, LAN 102 is established in association with connection of devices 108 to a same network access point device 106 (either directly or indirectly via another device), such as a wireless fidelity (WiFi) access point device. However, a client device 108 can connect to a LAN 102 using virtually any desired wired or wireless technology including, WiFi, Wi-Max, WLAN, Bluetooth M technology, etc. In an aspect, LAN 102 includes a private network such as an intranet that can include a virtual private network (VPN). In an aspect, one or more components of system 100 are configured to interact via disparate networks.

In an aspect, a client device 108 can employ local content sharing server 114 to share information identifying content or content times associated with a content provider 112 between one another based on connection of the respective client devices 108 to LAN 102. In particular, local content sharing server 114 can identify a set of devices joined by a LAN and facilitate sharing content items provided by a content provider 112 amongst only those devices included in the set. For example, where content provider 112 is a website that provides documents, articles, pictures, or media for streaming and/or downloading, one of the client devices 108 can employ local content sharing server 114 to facilitate sharing the documents, articles, and/or media amongst other client devices 108 connected to the same LAN 102 as the client device 108.

Accordingly, when a client device 108 is connected to the LAN 102, the client device can access content provider 112 (e.g., via a website or application associated with the content provider) and share a content item provided by content provider 112 with one or more of the other client devices connected to the LAN 102. For example, a user of a client device 108 can identify a content item for sharing provided by a content provider 112 and send a request to the content provider 112 to share the content item with other devices that are connected to the same LAN 102 the client device is connected to. The content provider 112 can then employ local content sharing server 114 to generate and send a notification to the other device that are connected to the same LAN as the client device that provides information identifying the shared content item. In the alternative, a user of a client device 108 can identify a content item for sharing provided by a content provider 112 and send a request to local content sharing server 114 to share the content item with other devices that are connected to the same LAN 102 the client device is connected to. The request can include information identifying the content item to be shared, including information identifying the network location of the content item (e.g., a URL for the content item at content provider 112). The local content sharing server 114 can then generate a notification identifying the shared content item (e.g., including the URL for the content item) and send the notification to the other devices connected to the LAN 102. Similarly, when a client device 108 is connected to the LAN 102, the client device can receive a content item shared from another device connected to the LAN when the other device requests to share the content item only with other devices connected to the LAN 102.

However, rather than allowing or requiring the clients devices 108 to pass the actual content items (e.g., document files, article files, media files, etc.) between one another, local content sharing server 114 facilitates sharing information identifying content items provided by content provider 112. The information identifying the content item does not include the actual content item or copy of the actual content item. For example, local content sharing server 114 can facilitate sharing a message or notification that identifies the title of a shared article and the webpage where the article is located. In another example, local content sharing server 114 can facilitate sharing a link to a content item provided by a content provider 112. As a result time and resources associated with transmitting, receiving and storing large files are saved. Identified content items included in a notification received by a device can be accessed from the content provider 112 from which they are associated via network 110 (e.g., using a browser or application provided on the device).

The term link or hyperlink refers to an object or item that serves as a reference to remote data, such as content provided by content provider 112. The terms link and hyperlink are used herein interchangeably. A link can be selected by a user to present the user with the data represented by the link. The effect of selecting a link can vary with the hypertext system used to generate the link, configuration of the link, and the system employed to render the link. For instance, on the World Wide Web, most hyperlinks cause a target object to replace an object being displayed, but some are marked to cause the target document to open in a new window. For example, depending on the device rendering the link and the configuration of the link, the link may open in a new browser window or tab. In another example, where the link is associated with an application provided on the device, the application can be configured to open the link. Another possibility is transclusion, for which the link target is a document fragment that replaces a link anchor within the source document. In an aspect, links to videos provided by content provider 112 (e.g., where content provider 112 is a media provider) are configured to cause the video represented by the link to begin playing as streamed from content provider 112 in response to selection of the link.

One reason users may want to share to the other devices connected to the same LAN as the user based may be to share with only those devices within close proximity of the user, which is often required for connection of the respective devices to the LAN. Another reason users may want to share with only users connected to the same LAN as the user may be because respective users are required to provide a secret password before becoming connected to the LAN. Accordingly, users may want to share with only those other users who are privy to the secret password and thus trusted by the user.

For example assume a user named Tom is having a party at his home. As background entertainment for the party, Tom is playing videos on his television that are streamed from a video sharing system to his laptop computer via a WAN (e.g., network 11) and then streamed from his laptop to his television via a LAN (e.g., his local WiFi network). Tom's friends at the party want to help pick out videos to play at the party. So Tom's friends connect to Tom's LAN via their smartphones and access the video sharing system through the LAN. Tom's friends then search for videos they would like to play at the party that are provided by the video sharing system. In the process of finding videos one of Tom's friends Steve finds a hilarious kangaroo video that he wants to share with the other people at the party.

Without the disclosed local content sharing methods, Steve can employ conventional sharing methods, such as sending an email or text message to respective people at the party with a link to the kangaroo video. However, Steve may not have contact information for everyone at the party. Steve may also decide it would be easier to just post the video on his social network account to share with all of his friends that are friends of his on his social networking account. However, Steve may not be social network friends with everyone at the party. Thus in order to share with everyone at the party, Steve would need to add everyone at the party to his social networking account. Yet everyone at the party may not want to be added to Steve's social networking account. The disclosed local content sharing methods solve Steve's problems by allowing him to share the video with everyone at the party simply by sharing to all the devices connected to Tom's LAN. Accordingly, the people who would like to receive shared information associated with the party can simply connect to Tom's LAN.

In another aspect, a content provider 112 can employ local content sharing server 114 to push content items provided by content provider 112 (or information identifying the content items) and/or provide access to content items, provided by content provider 112, to devices based on connection to those devices to a particular LAN. In particular, content provider 112 can provide devices links to files, media items, databases, etc., in response to connection of those devices to a particular LAN. For example, content provider 112 and/or local content sharing server 114 can store, receive or otherwise determine a list of authorized devices or users of the devices who are authorized to receive links or access to a particular content item provided by content provider 112 when connected to a particular LAN. The local content sharing server 114 can further determine when the authorized devices are connected to the LAN and push the content item or links to access the content item to the authorized devices.

According to this example, content provider 112 can include an entity that provides documents and materials associated with a medical conference being held at hotel Grand Gables on Saturday October 5th from 10 am to 2 pm. Hotel Grand Gables provides hotel guests access to a private LAN associated with the hotel. Content provider 112 can employ local content sharing server 114 to store a list of invitees to the conference. Local content sharing server 114 can be configured to identify devices connected to the private LAN of the hotel on Saturday October 5th around the time of 10 am to 2 pm. Local content sharing server 114 can then determine which of the connected devices or users of those connected devices are also included on the invitee list. Local content sharing server can then provide those invitees with a notification that includes a link to the documents and material for the conference that can be accessed at content provider via a network (e.g., the Internet).

In another example, content provider 112 can include an entity associated with a professor or educational system the professor is associated with. The professor can employ local content sharing server 114 to provide classroom notes or testing material stored by content provider 112 to students based on their classroom attendance on a scheduled class period as determined based on connection of devices employed by the students to a LAN associated with the classroom. For example, the classroom can be associated with Local Network Classroom A (LNCA). In order to connect to LNCA, a student must be located in or near the classroom. The professor can employ local content sharing server 114 to set of delivery of classroom materials or links to classroom materials that is conditional upon connection to LNCA during the window of time at which the class period is scheduled. According to this example, local content sharing server 114 can be configured to identify devices connected to LNCA during the window of time of the scheduled class period and send a link to the connected devices that provides access to classroom materials available at content provider 112 via a network. Local content sharing server 114 (as directed by the professor) can further configure the shared link with various restrictions or provisions. For example, local content sharing server 114 can configure the link so that it is not transferrable or accessible after certain time period. In another aspect, local content sharing server 114 can configure the link such that a notification can be provided to the professor in response to selection of the link.

In an embodiment, system 100 facilitates a method for sharing data links amongst devices connected to a same local network that involves three stages, a registration stage, a sharing request stage, and a notification stage. In the registration stage, local content sharing server 114 receives information identifying a set of devices currently connected to a particular LAN. The local content sharing server 114 can also receive authorization information from the respective devices indicating the respective devices have authorized or requested receipt of sharing notifications from local content sharing server 114 based on their respective connections to the particular LAN.

In an aspect, when a client device connects to a particular LAN (e.g., via a local WiFi access point device for the LAN), the client device can register itself with local content sharing server 114 as belonging to the LAN and request to receive sharing notifications from the local content sharing server 114. For example, after connecting to LAN 102, respective client devices 108 can send local content sharing server 114 information identifying themselves (e.g., a unique device identifier for the respective devices, such as a phone number, internet protocol (IP) address, media access control (MAC) address, etc.) and identifying LAN 102 (e.g., a unique identifier for access point 106, a unique identifier for LAN 102, etc.). Local content sharing server 114 can temporarily store this information to facilitate sending notifications to the respective devices. Local content sharing server 114 can continuously update information identifying devices currently connected to a particular LAN as devices disconnect from the LAN and new devices connect to the LAN. In an aspect, client devices 108 can fingerprint, encrypt or otherwise obfuscate information identifying a LAN before sending it to local content sharing server 114 (e.g., because it is not important for local content sharing server 114 to know specific information about the local network a device is connected to, only that two or more devices are connected to the same network).

In an aspect, by to sending local content sharing server 114 information identifying a LAN to which the device is currently connected, the device can inherently authorize local content sharing server 114 to send it notifications. In another aspect, local content sharing server 114 can request and receive authorization information from a client device 108 prior to sending the device sharing notifications.

In another aspect, a client device 108 can pass registration information to local content sharing server 114 via access of a webpage associated with local content sharing server 114 and/or content provider 112 that employs local content sharing server 114. According to this aspect, when a client device 108 accesses such a webpage (e.g., to view content provided by a content provider 112 via the webpage), local content sharing server 114 and/or the content provider associated with the webpage can identify the LAN employed by the device at the time of access. For instance, a browser employed by the client device to access the webpage can pass information to local content sharing server 114 and/or the content provider associated with the webpage identifying the LAN to which the device is connected. For example, local content sharing server 114 and/or the content provider 112 associated with the webpage, can employ a network application program interface (API) that provides an interface for web applications to access the underlying connection information of the device as described in the following publication, incorporated herein by reference: Mounir Lamouri. “The Network Information API. 29 Nov. 29, 2012. W3C Working Draft. (Work in progress.) URL: http://www.w3.org/TR/netinfo-api/, incorporated herein by reference.

System 100 can employ various other methods to register devices with local networks the devices are currently connected. For example, in another embodiment, registration of devices 108 can occur through a process involving WiFi Direct or Bluetooth technology, where devices themselves identify other devices on the same local network. From here, the devices 108 can employ a peer to peer method to identify local network occupants and pass a unique identifier for the local network around to each other so that all devices which can communicate with each other share the network identifier. In order to share information with other devices connected to the same local network, the sharing device can merely identify the local network in the local share request and send the information directly to other devices connected to the local network that are registered with the unique network identifier. When a device leaves the local network it can be configured to forget or erase the old network identifier. When two devices discover that they have different network identifiers for the same network, both devices can adopt the oldest network identifier and pass that oldest network identifier to other devices that may have been registered with a newer network identifier. Alternatively, the respective devices 108 can pass information identifying the local network established via peer to peer device pairing (e.g., the unique identifier created for the peer to peer network) to the local content sharing server 114. The local content sharing server 114 can then generate device clusters.

During the sharing request stage, a user of a client device 108 makes a request to share a content item provided by a content provider 112 (or another content provider) with other client devices 108 connected to the same LAN as the user's device. For example, where content provider 112 is a video sharing provider, using his client device, a user can interact with the video sharing provider via a website server of the video sharing provider or application server of the video sharing provider and identify a video for sharing. Using his client device, the user can send a request to the local content sharing server 114 or the video provider, where the video provider is configured to employ local content sharing server 114, to share the video with other devices connected to the same LAN which his client device is currently connected to. The request will include information identifying the video he has selected for sharing and the LAN to which his client device is currently connected. In an aspect, the request can include a URL for the video.

In the notification stage, the local content sharing server 114 receives a sharing request and identifies devices that are registered to the same LAN as a device from which a sharing request was received and sends a sharing notification to those devices. The sharing notification can include information identifying the content item shared but does not include the actual content item. For example, the sharing notification can include a link that is configured to cause the content item to open in a browser window at a client device that has received the notification upon selection of the link. In another example, the sharing notification can include a link that is configured to cause the content item to open in an interface generated by a local application provided on the client device.

In furtherance to the above, example, upon receiving the request to share the video by the videos sharing provider, the video sharing provider can employ local content sharing server 114 to identify other client devices connected to the same LAN as the client device from which the share request was received using information received during the registration stage. The local content sharing server 114 then generates a notification for those identified devices and sends the notification to those identified devices (e.g., using contact information for the respective devices or contact information for users associated with the respective devices). In an aspect, local content sharing server 114 can employ a centralized notification service or services associated with the respective client devices to facilitate sending sharing notifications.

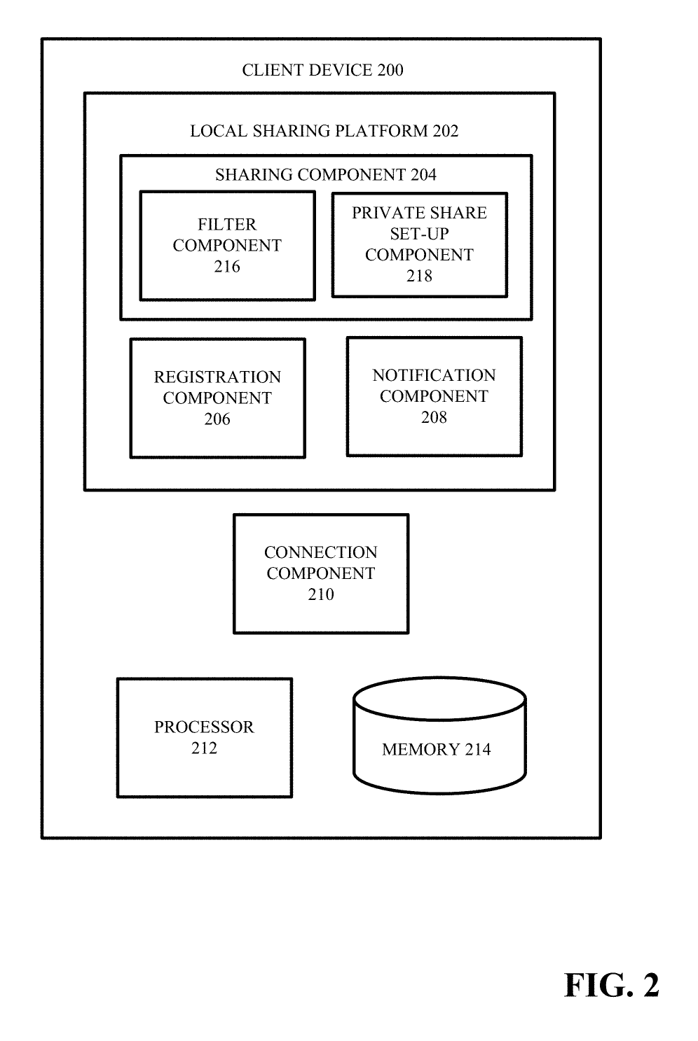

FIG. 2 illustrates an example client device 200 that can facilitate sharing information identifying content items remote from client device 200 with other devices based on connection of the other devices to a same LAN as client device 200 in accordance with various aspects and embodiments described herein. Client device 200 can include same or similar features and functionalities of as client device 108. Repetitive description of like elements employed in respective embodiments of systems and interfaces described herein are omitted for sake of brevity.

Client device 200 includes local sharing platform 202 to facilitate sharing content with devices connected to a same local network as client device 200 and to facilitate receiving shared content based on a local network client device 200 is connected to. In an aspect, local sharing platform 202 is an application, or is associated with an application, provided on client device 200. In another aspect (not shown), one or more components of local content sharing platform are located at a remote server (e.g., local content sharing server 114) accessible to client device 200 via a network (e.g., network 110). Client device 200 includes connection component 210 to facilitate connection of client device 200 to various networks described herein (e.g., LANs and WANs). Client device 200 can include memory 214 for storing computer executable components and instructions and processor 212 to facilitate operation of the instructions (e.g., computer executable components and instructions) by client device 200.

Local content sharing platform includes sharing component 204, registration component 206 and notification component 208. Registration component 206 is configured to facilitate registering client device 200 with a remote local content sharing server (e.g., local content sharing server 114) in association with a LAN with which client device 200 is currently connected. In an aspect, registration of client device 200 involves providing a remote local content sharing server information identifying client device 200 and/or a user of client device 200 and a LAN with which the client device is currently connected. The remote local content sharing server then registers client device 200 by associating client device 200 and/or the user of client device 200 with the LAN as being currently connected to the LAN (e.g., in memory accessible to the local content sharing server). In an aspect, registration of client device 200 with a remote local content sharing server further includes providing the remote local content sharing server with authorization to send client device 200 notifications regarding content shared to client device 200 based on connection of client device 200 to a particular LAN. Registration component 206 can also facilitate un-registering client device 200 when it disconnects from the LAN.

In an aspect, the registration/de-registration process is autonomous to a user of client device 200. For example, in response to connection of client device 200 to a LAN (e.g., via a WiFi access point) by connection component 210, registration component 206 can receive a unique identifier for the LAN and send the unique identifier to the remote content sharing server along with information identifying client device 200. In an aspect, registration component 206 can fingerprint, encrypt or otherwise obfuscate an identifier for the LAN prior to sending. Upon receipt of the information identifying client device 200 and the LAN client device 200 is currently connected to, the remote content sharing server can automatically register client device 200 as being connected to the LAN. In another example, in response to accessing an application or webpage that employs a remote local content sharing server to facilitate sharing content accessed via the application or webpage (e.g., an application or webpage associated with a content provider 112 that employs local content sharing server 114 to facilitate sharing information provided by the content provider 112), information identifying client device 200 and the LAN to which the client device is currently connected can be passed to the remote local content sharing server (or otherwise determined by the remote local content sharing server). For example, a browser provided on client device 200 used to access the webpage can pass information identifying the LAN to which client device is connected to the remote local content sharing server. Upon receipt of information identifying client device 200 and the LAN to which client device 200 is currently connected, the remote local content sharing server can automatically register client device 200 as being connected to the LAN.

In another aspect, registration component 206 can receive or otherwise determine information identifying a LAN to which client device 200 is connected in response to connection of client device 200 with the LAN. However, prior to sending the information identifying client device 200 and the LAN to which client device 200 is currently connected to the remote local content sharing server, registration component 206 can generate a prompt at client device 200 requesting user input to authorize registration of client device 200 with the remote local content sharing server. For example, via a prompt, registration component 206 can ask the user if the user would like to receive sharing notifications based on connection to the LAN. In response to user input authorizing receipt of such notifications, registration component 206 can send the information identifying client device 200 and the LAN to which client device 200 is currently connected.

The authorization prompt can vary depending on the implementation of the remote local content sharing server with which the device will be registered. For example, where local sharing platform 202 is configured to communicate with a local content sharing server that facilitates sharing content between devices connected to a same LAN, the prompt can ask the user to authorize receiving notifications initiated by other devices connected to the same LAN as the client device. In another example, where local sharing platform 202 is configured to communicate with a local content sharing server that pushes information to a device based on a particular LAN the device is connected to, the prompt can ask a user of the device whether the user would like to receive information associated with the LAN to which his device is currently connected.

In a similar aspect, registration component 206 can receive or otherwise determine information identifying a LAN to which client device 200 is connected in response to access, by client device 200, of an application or webpage associated with a content provider configured to employ a remote local content sharing server (e.g., local content sharing server 114) to facilitate sharing information provided by the content provider. However, prior to sending or providing the information identifying client device 200 and LAN with which the client device 200 is currently connected to, registration component 206 can generate a prompt at client device 200 requesting user input to authorize registration of the client device 200 with the remote local content sharing server. In an alternative aspect, rather than registration component 206 initiating generation of the authorization prompt, the content provider/remote local content sharing server can be configured to request user authorization in association with registering a device as belonging to a LAN with which the device is connected. In response to input affirming registration by the user, registration component 206 can be configured to send information identifying client device 200 and the LAN to which the client device is connected, to the content provider/remote local content sharing server. Upon receipt of the information, the remote local content sharing server then registers client device 200 as being currently connected to the LAN.

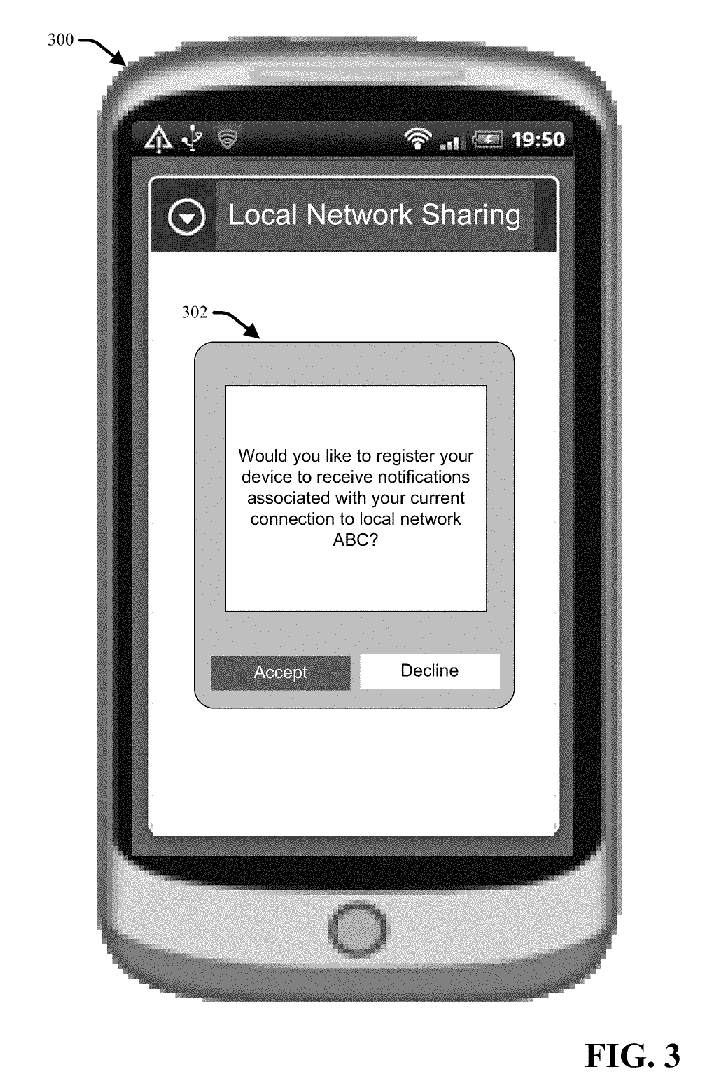

FIG. 3 presents an example interface displayed at a client device 300 that includes an authorization prompt 302 in association with registering the device with a remote local content server configured to provide notifications to the device based on connection of the device to a particular LAN. Client device 300 can include same or similar features as client device 200. In an aspect, registration component 206 generates authorization prompt 302 in response to connecting client device 300 to local network ABC. In response to user input accepting the registration prompt, registration component 206 can send information identifying client device 300 and local network ABC to a remote local content sharing server (e.g., local content sharing server 114). The remote local content sharing server can then register device 300 as being currently connected to local network ABC.

Referring back to FIG. 2, registration component 206 can facilitate de-registration of client device 200 with a remote local content sharing server (e.g., local content sharing server 114) using a mechanism similar to that employed to register client device 200. For example, in response to disconnection of client device 200 from a LAN to which client device 200 is registered, registration component 206 can receive information from connection component 210 indicating that client device 200 is no longer connected to the LAN. Registration component 206 can further send a de-registration message to the remote local content sharing server with which client device 200 is registered informing the remote local content sharing server that client device 200 is no longer connected to the LAN. The remote local content sharing server can un-register client device 200 with respect to the LAN with which the client device is no longer connected.

Sharing component 204 is configured to facilitate sharing information identifying content located at a remote content provider accessible to client device 200 via a network, (e.g., a content provider 112 and network 110), with other devices based on connection of client device 200 and the other devices to a same LAN. In an aspect, sharing component 204 is configured to generate a request to share a content item with another device connected to a same LAN as client device 200. Such a request is referred to herein as a local sharing request. For example, the content item can include a video, channel, or playlist associated with a remote video sharing system configured to provide streaming video via network. In another example, the content item can include a picture, album, article, or a comment provided on a social networking website. Still in another aspect, the content item can include a website or webpage. Sharing component 204 is further configured to send the local sharing request to a remote local content sharing server (e.g., remote local content sharing server 114). The request includes information identifying the content item to be shared, the client device making the request, and/or the LAN with which the client device making the request is currently connected to. In an aspect, the information identifying the content item to be shared includes a URL for the content item.

According to this aspect, in response to identifying a content item accessible to client device 200 via a network (e.g., located at a remote content provider 112) that a user of client device 200 would like to share, the user can select a share command associated with a program provided on client device 200 and/or a webpage or application associated with the content item. In association with selection of the share command, sharing component 204 can provide the user with an option to share the content item with other devices connected to the same LAN as client device 200. For example, sharing component 204 can generate a sharing prompt that includes a menu option to share the content item with other devices connected to the same LAN as client device 200. In response to selection of the option to share the content item with other devices connected to the same LAN as client device 200, sharing component 204 can configure a local sharing request message that includes information identifying the content item to be shared, client device 200 and/or the LAN with which client device 200 is currently connected to.

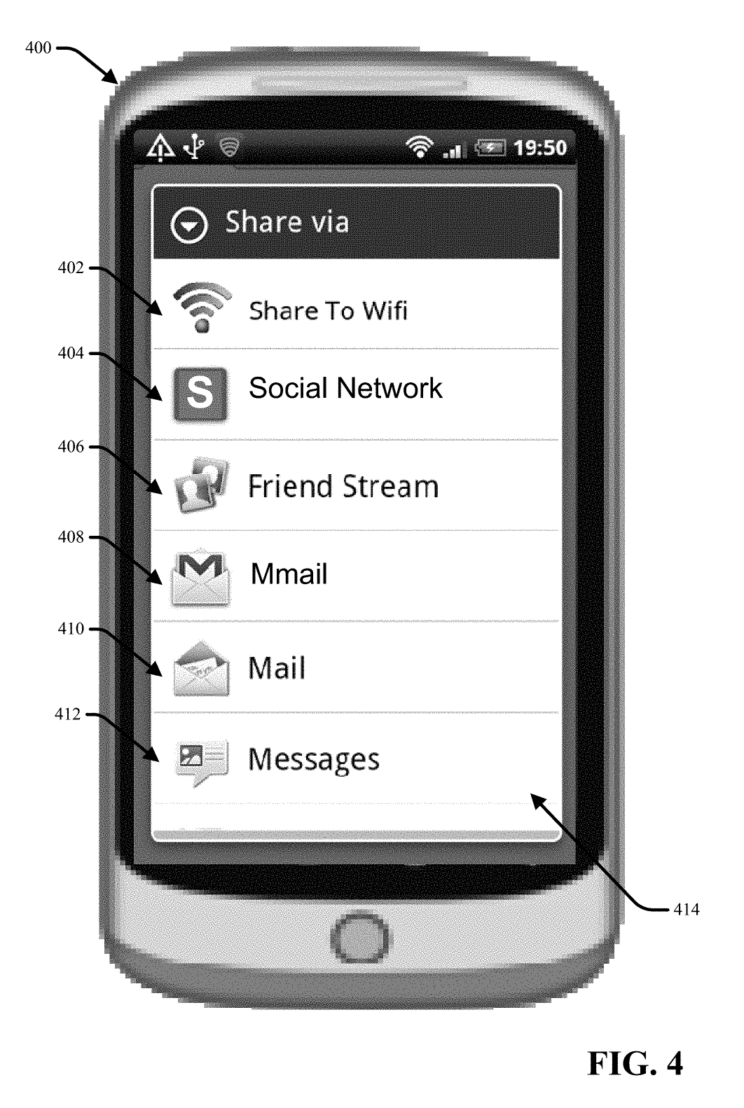

FIG. 4 presents an example interface 414 displayed at a client device 400 that facilitates initiating a local share request. In an aspect, interface 414 is generated by a sharing component (e.g., sharing component 204) associated with a local content sharing platform (e.g., local sharing platform 202) provided on client device 400. Client device 400 is a mobile phone, such as a smartphone. However, it should be appreciated that interface 414 can be adapted for display at other types of client devices.

In an aspect, a user of client device 400 has identified a content item he would like to share with other users within a relatively close proximity to the user (e.g., within his home or office). The content item can include a content item provided by a remote content provider (e.g., a content provider 112) accessed using client device 400 via a network. For example, a user of client device 400 may have opened a streaming video provider's website or application using client device 400 and identified a video associated with the streaming video provider the that he would like to share. According to this example, interface 414 can be generated (e.g., by sharing component 204) in response to selection of a sharing option associated with the device, website, and/or application that facilitates generating the sharing menu displayed by interface 414. The sharing menu can include various different options or mechanisms to share the video. For example, option 402 includes an option to share to WiFi, option 404 includes an option to share to a social network, option 406 includes an option to share on a friend stream, option 408 includes an option to share via Mmail, option 410 includes an option to share via regular mail, and option 412 includes an option to share using a text a short messaging service.

In aspect, respective options 402-412 can facilitate sharing information identifying a content item to be shared. For example, where the content item is a video, respective options 402-412 can facilitate sharing a link to the video and/or embedding a video player configured to play the video as streamed from the video provider. In an aspect, the user can select the “share to WiFi” option 402 to share information identifying the video with other devices that are connected to the same LAN or WiFi network as the client device. For example, in response to selection of the share to WiFi option 402, other devices that are connected to the same WiFi network as client device 400 and that have registered with a local content sharing server, as described herein, can receive a notification from the local content sharing server. The notification can include information identifying the shared video. In aspect, the notification can include a link to the shared video. The notification can also include information identifying the user who shared the video.

Referring back to FIG. 2, after sharing component 204 has configured a local sharing request, sharing component 204 sends the local sharing request to a remote local content sharing server (e.g., local content sharing server 114). Sharing component 204 can send the local sharing request to the remote local content server either directly or indirectly via the content provider associated with the shared content item where the content provider is configured to relay the local sharing request to the remote local content sharing server. In an aspect, sharing component 204 can fingerprint, encrypt, or otherwise obfuscate information included in a local sharing request message identifying the LAN. According to this aspect, other devices registered with the LAN at the remote local content sharing server will be configured to fingerprint, encrypt, or otherwise obfuscate the information identifying the LAN in the same manner prior to sending the information to the information to the remote local content sharing server.

Upon receipt of a local sharing request, the remote local content sharing server processes the request and sends a notification to the other devices connected to the same LAN as client device 200 and registered with the remote local content server. The notification includes information identifying the shared content item, such as a link to the shared content item. For example, after a local sharing request is received, the remote local content sharing server identifies other client devices connected to the same LAN as client device 200 from which the sharing request message was sent using registration information stored in memory accessible to the remote local content sharing server. The registration information identifies other devices that have been registered with the remote local content sharing server as being currently connected to the same LAN identified in the sharing request message. In an aspect, client device 200 does not need to be registered with the remote local content sharing server in order to send a request to share content with other devices connected to the same LAN as client device 200. However, client device 200 does need to be registered with the remote local content sharing server in order to receive sharing notifications from other devices based on connection of client device 200 to a same LAN as the other devices.

Sharing component 204 can also include filter component 216 and private share set-up component 218. Filter component 216 facilitates applying various additional filters and specifications regarding recipients of content shared based on connection to a same LAN as client device 200. For example, a user of client device 200 may not want to share a content item with everyone connected to a same LAN as his device. He may only want to share the content item with users of devices that are connected to the LAN and that are his friends on social network “MyFriendsBook.com.” For example, where client device 200 is connected to a public WiFi network, such as a network provided by a local coffee shop, the user of client device may not want to share with everyone else connected to the public WiFi connection. Rather, the user may only want to share with people connected to the public WiFi connection that are friends of his on “MyFriendsBook.com,” or that are around is age. In another example, the user of client device 200 may only want to share a content item with those users who are over the age of 18 and connected to the same LAN as the user's device.

In accordance with these examples, filter component 216 provides a mechanism to filter a local sharing request using various additional restrictions or parameters in addition to mere association with the user based on connection to a same LAN. In an aspect, filter component 216 can apply filters to a sharing request that restricts recipients of shared content by a social network affiliation, a demographic, a location, or a user preference. For example, using filter component 216, a user of client device 200 can request to share a news article with those users who are connected to the same LAN as client device 200 and who are affiliated with the user on a particular social network. In another example, using filter component 216, a user of client device 200 can request to share a link to a motocross video with those users who are connected to the same LAN as client device 200 and who like motocross sports. In another example, using filter component 216, a user of client device 200 can request to share a campaign video with users who are connected to the same LAN as client device 200 and who are affiliated with a particular political party.

In association with processing a local sharing request that has filters applied thereto related to features and requirements of the target recipients aside from connection to a same LAN as the device from which the sharing request was receive, the remote local content sharing server that services the sharing request (e.g., local content sharing server 114) can access information associating registered devices with information about respective users of the registered devices provided at various network resources. For example, the remote local content sharing server can access and associate registered devices with one or more profiles established for respective users of the registered devices at various remote content providing systems (e.g., social networking profiles, video watching profiles, picture sharing profiles, educational enrollment profiles, etc). The user profiles can include information including but not limited to: preferences of the respective users, social affiliations and connections of the respective users, and demographics of the respective users.

Private share set-up component 218 is configured to facilitate setting up a local share request to share content provided by a remote content provider (e.g., content provider 112) with another device at a future date and time based at least on connection of the other device to a particular LAN. According to this aspect, using private share set-up component 218 a user of client device 200 can identify a content item he would like to share with other users at a future point in time that is conditional upon those other users being connected to a specified LAN. The private share set-up component 218 can also apply various other filters described in association with filter component 216 that restricts what recipients will receive the shared content in addition to restriction of the recipients based on connection to a particular LAN.

For example, using private share set-up component 218, John, a user of client device 200, can send a request to a remote local content sharing server (e.g., local content sharing server 114) to share a playlist provided at a remote content provider (e.g., content provider 112) with other devices connected to his home LAN. The request can include information identifying his home LAN and the playlist. As other users arrive at John's house, connect to John's home LAN with their respective devices, and become registered with the remote local content sharing server, they can receive a notification with a link to the playlist. In another example, using private share set-up component 218, a user of client device 200 can send a request to a remote local content sharing server (e.g., local content sharing server 114) to share classroom materials provided at a remote content provider (e.g., a content provider 112) to devices connecting to local area network A (LNCA) from 1 pm to 2 pm on Oct. 28, 2013. In response to connection and registration of a device with LNCA between 1 pm to 2 pm on Oct. 28, 2013, the device can be sent a notification from the remote local content sharing server with a link to access the classroom materials at the remote content provider.

Notification component 208 is configured to receive notification messages from a remote local content sharing server (e.g., local content sharing server 114) identifying content shared with client device 200 based on connection of client device 200 to a particular LAN and registration of client device 200 with the remote local content sharing server. In an aspect, notification component 208 can receive a notification with information identifying a content item provided by a remote content provider (e.g., a content provider 112) and shared with client device 200 from another device connected to a same LAN as client device 200. For example, the notification can include a link to a media item, website, blog, or document shared with a user of client device 200 based on connection of client device 200 to a same LAN as the device who initiated sharing the link.

In another aspect, notification component 208 can receive a notification identifying a content item shared with client device 200 by a provider of the content item based on connection of client device 200 to a particular LAN. For example, a remote content provider (e.g., content provider 112) can include a coupon distributer configured to send links to coupons associated with an entity provided at a location associated with a particular LAN. The coupon distributer can employ a remote local content sharing server (e.g., local content sharing server 114) to facilitate sending the coupons to devices when the devices connect to the particular LAN. In response to connecting to the particular LAN, client device 200 can receive a notification that includes a coupon from the remote local content sharing server.

In addition to information identifying a shared content item, a notification received by notification component 208 can include information identifying the user and/or device who initiated sending the content item identified in the notification. According to this aspect, the information identifying the sender of the shared content item can be explicitly provided to the recipient and/or implicitly included in the notification message as an attribution tag. Also according to this aspect, a notification message received by a client device can be forwarded or resent to another client device. However, the original device that initiated sending the content item identified in the notification can be tracked, regardless of the number of intermediary devices the notification travels through.

Notification component 208 is further configured to present of facilitate presenting notification messages received from a remote local content server (e.g., local content sharing server 114) to a user of client device 200. For example, notification component 208 can employ a notification application or program associated with client device 200 configured to present notifications to a user in a systematic manner regardless of the application (e.g., local sharing platform 202) associated with the notification. According to this example, the notification component 208 can provide the a received notification message to the notification application or program running at client device 200 which then generates a graphical icon and associated descriptive text with the notification that is displayed via an interface generated at client device 200. In another aspect, the notification can be association with a distinguishing sound effect. The notification can also include selectable content that results in the display of information included in the notification via a new browser window or via an application provided on client device 200 associated with the content item represented in the notification. For example, the notification can include a link to a video that causes the video represented by the link to open in a browser window that displays a webpage where the video is located or an application associated with a provider of the video.

In another aspect, notification component 208 can generate a popup display message or other graphical icon indicating a notification message has been received. In some aspects, an icon or sound effect representative of a notification of shared local content can merely indicate that a notification message has been received at an external messaging client associated with the remote local content sharing server or content provider employing the local content sharing server. In order to view the contents of the notification message (e.g., a link to the shared content item), a user can employ a browser or application to access the external messaging client which then displays the contents of the notification message.

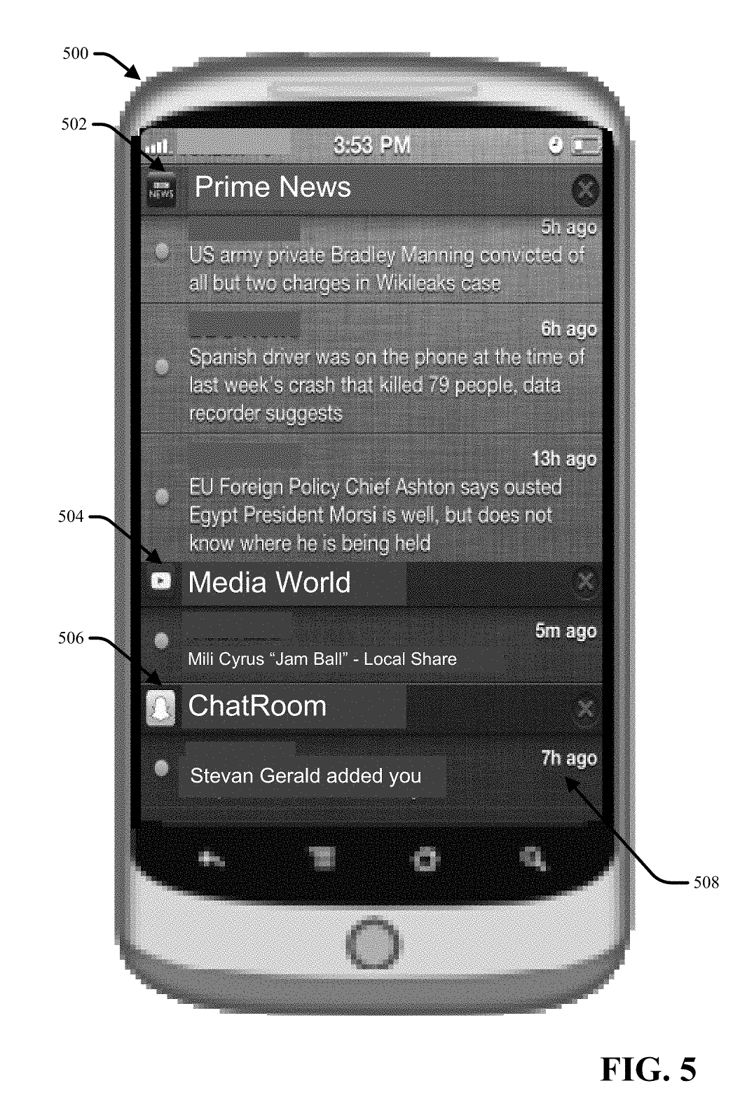

FIG. 5 presents an example interface 508 displayed at a client device 500 that includes a notification message identifying a video that was shared with the device from another device connected to a same LAN as client device 500. The video is associated with or provided by a remote content provider called “Media World.” In an aspect, interface 508 is generated by a notification component (e.g., notification component 208) that is associated with a local content sharing platform (e.g., local sharing platform 202) provided on client device 500. In another aspect, interface 508 is generated by a notification system associated with an operating system employed by client device 500. Client device 500 is a mobile phone, such as a smartphone. However, it should be appreciated that interface 508 can be adapted for display at other types of client devices.

Interface 508 includes various notifications associated with different applications provided on client device 500. For example, client device 500 includes an application for Prime News 502, Media World 504, and ChatRoom 506. Each of these applications are associated with various notifications that can be understood by a user of client device 500. For example, the notification associated with Prime News includes recent news stories. The notification for Media World indicates that a video entitled “Jam Ball” that has been shared with client device 500 or a user of client device 500. The notification associated with ChatRoom indicates that Stephen Gennaoui recently added the user of client device 500 to his ChatRoom account.

The notification of the shared video “Jam Ball” is generated and presented at client device 500 in response to receipt of a notification message indicting the video was shared with client device 500 by another device connected to a same LAN as client device 500. This is indicated by the tag “local share” associated with the notification. This local share notification was received from a remote local content sharing server (e.g., local content sharing server 114) with which client device 500 is registered in response to a request by another device connected to the same LAN as client device 500 to share the video “Jam Ball” with other devices connected to the LAN.

It should be appreciated that interface features associated with notification messages related to content shared with a device based on connection to a particular LAN described in interface 508 are merely exemplary. In particular, the contents and appearance of a notification message can vary depending on an operating system and display parameters of device at which the notification message is presented.

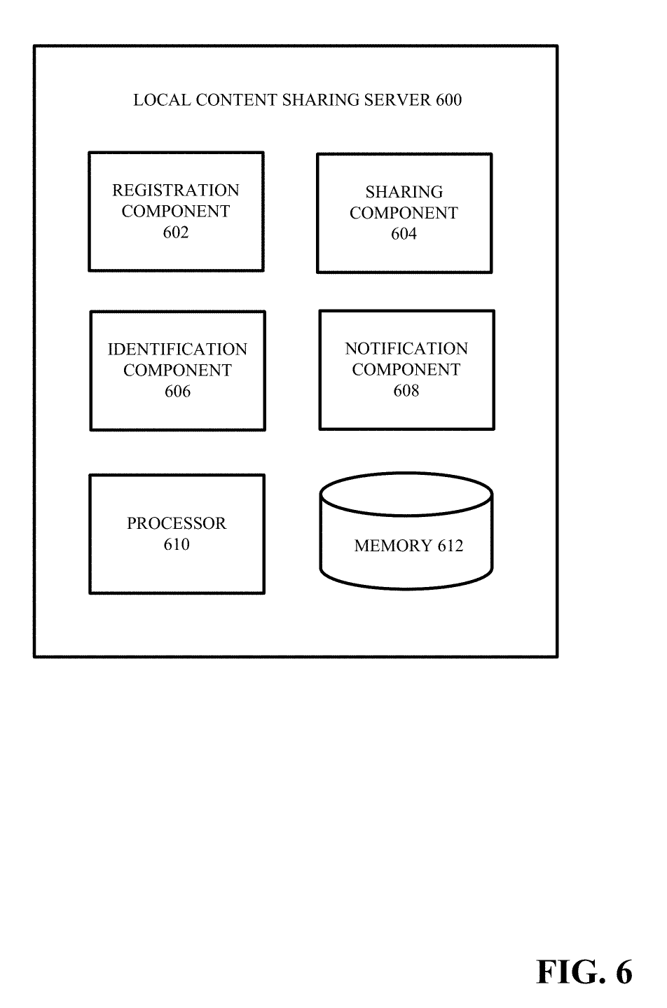

Turning now to FIG. 6 presented is an example local content sharing server that 600 can facilitates sharing content with devices based on connection of the devices to a particular LAN in accordance with various aspects and embodiments described herein. Local content sharing server 600 can include same or similar features and functionalities of as local content sharing server 114. Repetitive description of like elements employed in respective embodiments of systems and interfaces described herein are omitted for sake of brevity.

Local content sharing server 600 is configured to receive and process local content sharing requests initiated by a client device (e.g., client device 108 or client device 200) to share content items (e.g., information identifying content items) with other devices within close proximity to the client device based on connection to a same LAN as the client device. For example, local content sharing server 600 can receive a request, initiated by a first client device, to share a link to a content item, accessed by the first client device via a network, with other devices that are connected to a same LAN as the first client device. Local content sharing server 600 can process the request by identifying those other devices connected to the same LAN as the first client device and sending those other devices a notification that includes a link to the content item. Local content sharing server 600 can also be configured to push or otherwise provide notifications to client devices based in part on connection of the client devices to a particular LAN. For example, local content sharing server 600 can access or identify content that has been associated with a particular LAN. In response to connection of a device to that particular LAN, local content sharing server 600 can send the device a notification with information identifying the content or providing the device access to the content. In some aspects, the notification can include a promotional coupon or electronic gift.

In an aspect, local content sharing server 600 is accessed and employed by content providers (e.g., content providers 112) via a network (e.g., a network 110) to facilitate sharing content provided by the respective content providers among devices connected to a same local network. In another aspect, local content sharing server 600 can be included or integrated with a content provider to facilitate sharing content provided by the content provide among devices connected to a same local network. According to this aspect, the content provider can communicate with local content sharing server 600 directly or via a network.

Local content sharing server 600 includes registration component 602, sharing component 604, identification component 606 and notification component 608. Local content sharing server 600 can include memory 612 for storing computer executable components and instructions and processor 610 to facilitate operation of the instructions (e.g., computer executable components and instructions) by local content sharing server 600.

Registration component 602 is configured to register a client device (e.g., client device 108 or 200) in association with a LAN with which the client device is currently connected. In an aspect, registration component 602 is configured to receive information identifying a client device (e.g., a phone number, MAC ID, or other type of unique device identifier) and/or a user of the client device and a LAN to which the client device is currently connected. Upon receiving this information, registration component 602 can associate, in memory 612, the client device and/or user of the client device with the LAN as being currently connected to the LAN. For example, registration component 602 can receive this information from a client device in response to connection of the client device to the LAN. In another example, registration component 602 can receive this information from a content provider in response to access of an application or webpage associated with the content provider by a client device. According to this example, the application server or web server associated with the content provider servicing the application or webpage, respectively, can extract information identifying the client device or user of the client device and LAN to which the client device is connected in response to access of the application or webpage by the client device. The application server or web server can then relay this information to local content sharing server 600.

In an aspect, registration component 602 can require authorization information from a client device prior to registering the client device with a LAN to which it is connected. According to this aspect, registration component 602 can receive authorization information from a client device, authorizing local content sharing server 600 to send notifications to the client device based on connection to a particular LAN. In an aspect, registration component 602 can request authorization information from a client device prior to registering the client device with a particular LAN to which it is connected.

Registration component 602 can also un-register a client device when it disconnects from a LAN to which it is registered as being currently connected to. For example, in response to disconnection of a registered client device from a LAN, registration component 602 can receive a notification from the client device informing local content sharing server 600 that it has disconnected from the LAN. The registration component can then unregister or disassociate the client device and/or user of the client device from the LAN in memory 612.

Sharing component 604 is configured to receive and process local content sharing requests. In particular, sharing component 604 is configured to receive a request from a client device, connected to a LAN, to share a content item with one or more other devices connected to the LAN. The local content sharing request will include information identifying the content item and information identifying the LAN and/or the client device from which the request was received. For example, if the client device was previously registered with local content sharing server 600, using information identifying the client device, sharing component can identify the LAN to which the client device is currently connected. If the client device was not previously registered with local content sharing server 600, the request will include information identifying the LAN to which the client device is currently connected. In an aspect, information identifying the content item to be shared includes a URL for the content item.

Identification component 606 is configured to identify recipients of a shared content item in association with a received local share request. In particular, identification component 606 can identify devices, or users of the devices, with which to share a content item identified in a local share request. For example, where the local share request includes a request to share a content item with all other users of devices connected to a same LAN as the device that initiated the request, identification component 606 can identify the other devices that connected to the same LAN as the client device. In order to identify devices, or users of the devices, connected to a same LAN as the client device from which the local sharing request was received, identification component 606 can employ registration information stored in memory 612 that identifies what devices and/or users of those devices that are currently connected to the same LAN as the client device from which the local sharing request was received.

Notification component 608 is configured to generate a notification message in response to a local share request and send the notification message to the appropriate recipients of the local share request identified by identification component 606. The form and contents of a notification message can vary depending on the mechanism employed by notification component 608 to send the notification message and the mechanism employed by the receiving client device to render the notification message. In an aspect, the notification message can include information identifying the shared content item. For example, the notification message can include a URL for the shared content item. In another aspect, the notification message can include information identifying the device or user associated with the device that initiated sharing of the content item. The notification can also include information indicating that the notification was sent from another device connected to a same LAN as the receiving device and/or based on connection of the receiving device to a particular LAN. Still in other aspects, the notification message can include a graphical icon or sound effect that indicates a content item was shared with the recipient device or user based on connection of the device the LAN that the device is currently connected.

Notification component 608 is further configured to send notification messages to the appropriate devices or users of the devices connected to the same LAN as the client device that initiated a local share request using contact information for the devices or users of the devices. In an aspect, notification component 608 can determine contact information for the recipient devices connected to the same LAN as the device that initiated the local share request using contact information that was employed by the recipient devices when registering with local content sharing server 600. For example, in association with registering devices with a LAN, the devices provide local content sharing server 600 with information identifying the respective devices. In an aspect, the information can include contact information for the respective devices or users of the respective devices or information that can be employed by local content sharing server to look up (e.g., via an external or internal information database) contact information for the respective devices or users of the respective devices. For example, the contact information can include phone numbers associated with the respective devices. In another example, the contact information can include user profile accounts associated with the respective devices. In another example, the contact information can include electronic messaging addresses associated with the respective devices. In yet another example, the contact information can include unique identifiers for the respective devices that can be employed by local content sharing server 600 to identify contact information associated with the respective devices or users or the respective devices.

In an aspect, where a recipient device is a smartphone and the contact information for the recipient device is a phone number associated with the device, notification component 608 can configure and send a notification message for interpretation and presentation at the device using a notification system employed by the device (e.g., a notification system central to the operating system of the device). In another aspect, where the recipient device is a mobile phone, notification component 608 can employ a short messaging service (SMS) to configure and send the notification message using an SMS message. Still in another aspect, notification component 608 can send a notification message, with information identifying a shared content item, to a user account associated with a user of a device that is connected to a same LAN as the device that initiated the local sharing request. For example, the user account can include an account with a remote content provider that provides the content item shared in the notification message. The notification message can be rendered in association with access of the user account at a webpage or application employed by the content provider. The notification message can include information identifying the shared content item and indicating the content item was shared with the user based on connection to a same LAN as the device that initiated sharing the content item.

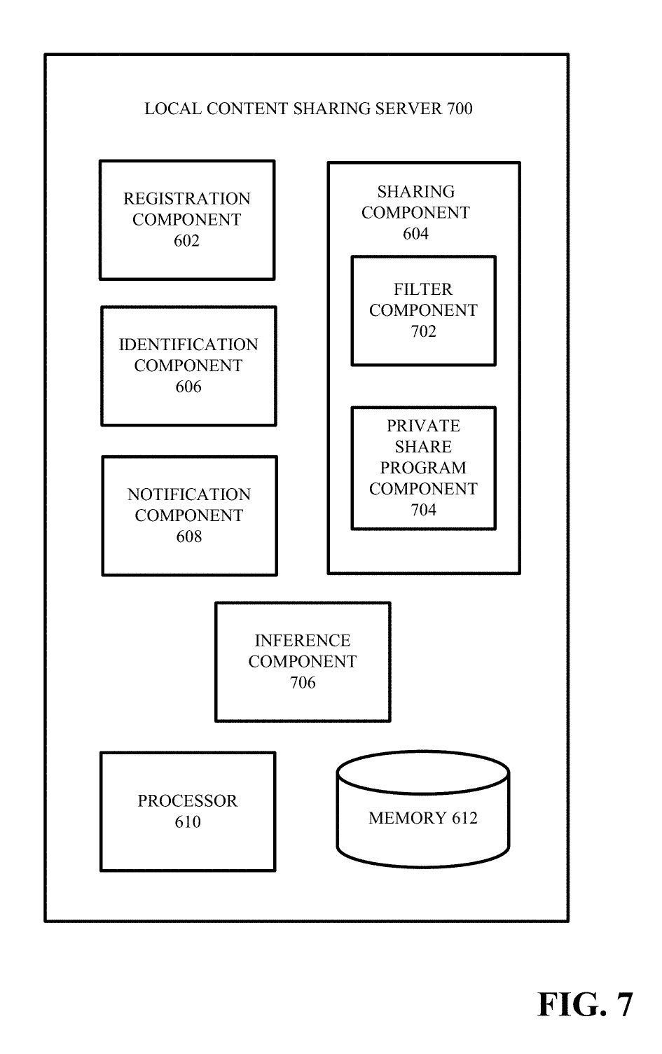

FIG. 7 presents another example local content sharing server that 700 can facilitates sharing content with devices based on connection of the devices to a particular LAN in accordance with various aspects and embodiments described herein. Local content sharing server 700 can include same or similar features and functionalities of as local content sharing server 600 and 114, and vice versa. Local content sharing server 700 includes the addition of filter component 702 and private share program component 704 to sharing component 604. Repetitive description of like elements employed in respective embodiments of systems and interfaces described herein are omitted for sake of brevity.

In an aspect, filter component 702 is configured to apply various filters or parameter restrictions in a received local share request that restrict possible recipients of the content item identified in the local share request. For example, as discussed with respect to filter component 216, when initiating a local share request, a user can filter the local sharing request using various additional restrictions or parameters in addition to mere association with the user based on connection to a same LAN. For example, a local share request and include a request to filter recipients based on a social network affiliation, a demographic, a location, or a user preference. Filter component 702 is configured to apply various filters included in a local share request by the user initiating the local share request. In an aspect, filter component 702 can employ identification component 606 to identify a subset of devices connected to a same LAN as the device that initiated the sharing request based on one or more filters applied to the local share request.

In association with processing a local sharing request that has filters applied thereto related to features and requirements of the target recipients aside from connection to a same LAN as the device from which the sharing request was receive, remote local content sharing server 700 can access information associating registered devices with information about respective users of the registered devices provided at various networked resources. For example, remote local content sharing server 700 can access and associate registered devices with one or more profiles or user accounts established for respective users of the registered devices at various remote content providing systems (e.g., social networking profiles, video watching profiles, picture sharing profiles, educational enrollment profiles, etc). The user profiles can include information including but not limited to: preferences of the respective users, social affiliations and connections of the respective users, and demographics of the respective users.

Private share program component 704 is configured to receive and program requests to share a predetermined content item with a device based in part on connection of the device to a predetermined LAN. For example, as described with respect to private share set-up component 218, a user can send a request to local content sharing server to share a specific content item with one or more devices at a future date and/or time based at least in part on connection of the device to a particular LAN identified in the request. The request can also include various restrictions regarding who can receive the content item, when the content item can be received, and how a notification identifying the content item should be configured. In another example, a content provider (e.g., a content provider 112) can send a private share program request to local content sharing server 700 that identifies content to be sent to a device in response to connection of the device to a particular LAN identified in the request (e.g., a link to classroom materials, a link to a playlist, a coupon, etc.).

Private share program component 704 can receive these pre-programmed local share requests and store them in memory 612. Private share program component 704 can further monitor when a device connects to a LAN identified in a private share program request and whether any other conditions defined in the private share program request have been satisfied. For example, private share program component 704 can identify any suitable device that connects to a particular LAN defined in a private share program request and send the device a notification with information identifying a content item associated with the provide share program request in response to connection to the particular LAN. In another example, private share program component 704 can identify devices that connect to a particular LAN defined in a private share request during a specified window of time identified in the private share program request.

In response to the occurrence and satisfaction of conditions defined in a private share program request, private share program component 704 is configured to instruct notification component 608 to send out a notification to the appropriate recipients (e.g., recipients satisfying the conditions outlined in the request) including information identifying the content item associated with the private share program request.

Inference component 706 is configured to provide for or aid in various inferences or determinations associated with aspects of local content sharing server 700. In aspect, all or portions of local content sharing server 700 can be operatively coupled to inference component 706. Moreover, inference component 706 can be granted access to all or portions of remote content sources (e.g., a content provider 112), external information sources and client devices (e.g., client device 108 or 200).

In an aspect, inference component 706 can facilitate inferring a subset of devices, or user of the devices, to send notifications to in association with a local share request or private share program request. For example, inference component 706 can facilitate filter component 702 and identification component 606 with respect to determining a subset of client devices connected to a same LAN as a device from which a local share request was received, that satisfy various filters applied to the local share request that restrict intended recipients (e.g., based on social network affiliations, based on user preferences, based on demographics, based on location, based on user context, etc.). In another aspect, inference component 706 can automatically infer one or more filters to apply to a local share request or private share program request. For example, inference component 706 can identify devices connected to a LAN identified in a local share request that should not receive a notification based on various reasons (e.g., context of the device, preferences of a user of the device, location of the device, watch history of a user of the device, previous notifications sent to the device, etc.). Inference component 706 can then instruct identification component 606 to remove those devices from the list of recipients to receive notifications associated with the local share request.

In order to provide for or aid in the numerous inferences described herein, inference component 706 can examine the entirety or a subset of the data to which it is granted access and can provide for reasoning about or infer states of the system, environment, etc. from a set of observations as captured via events and/or data. An inference can be employed to identify a specific context or action, or can generate a probability distribution over states, for example. The inference can be probabilistic—that is, the computation of a probability distribution over states of interest based on a consideration of data and events. An inference can also refer to techniques employed for composing higher-level events from a set of events and/or data.

Such an inference can result in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines, etc.) can be employed in connection with performing automatic and/or inferred action in connection with the claimed subject matter.

A classifier can map an input attribute vector, x=(x1, x2, x3, x4, xn), to a confidence that the input belongs to a class, such as by f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

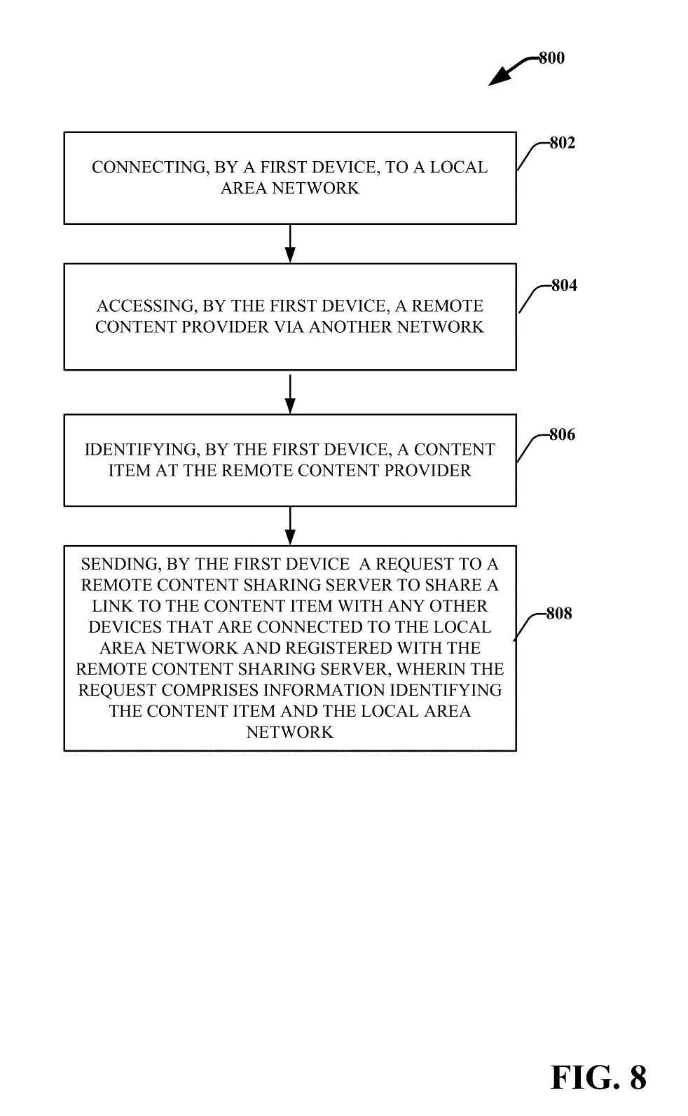

In view of the example systems and/or devices described herein, example methods that can be implemented in accordance with the disclosed subject matter can be further appreciated with reference to flowcharts in FIGS. 8-10. For purposes of simplicity of explanation, example methods disclosed herein are presented and described as a series of acts; however, it is to be understood and appreciated that the disclosed subject matter is not limited by the order of acts, as some acts may occur in different orders and/or concurrently with other acts from that shown and described herein. For example, a method disclosed herein could alternatively be represented as a series of interrelated states or events, such as in a state diagram. Moreover, interaction diagram(s) may represent methods in accordance with the disclosed subject matter when disparate entities enact disparate portions of the methods. Furthermore, not all illustrated acts may be required to implement a method in accordance with the subject specification. It should be further appreciated that the methods disclosed throughout the subject specification are capable of being stored on an article of manufacture to facilitate transporting and transferring such methods to computers for execution by a processor or for storage in a memory.

FIG. 8 illustrates a flow chart of an example method 800 for sharing data links with devices based on connection of the devices to a same local network in accordance with aspects described herein. At 802, a first device connects to a local area network (e.g., via connection component 210). At 804, the first device accesses a remote content provider via another network (e.g., a WAN). At 806, the first device identifies a content item at the remote content provider. At 808, the first device sends a request to a remote content sharing server to share a link to the content item with any other suitable devices that are connected to the local area network and registered with the remote content sharing server (e.g., using sharing component 204). The request includes information identifying the content item and the local area network.

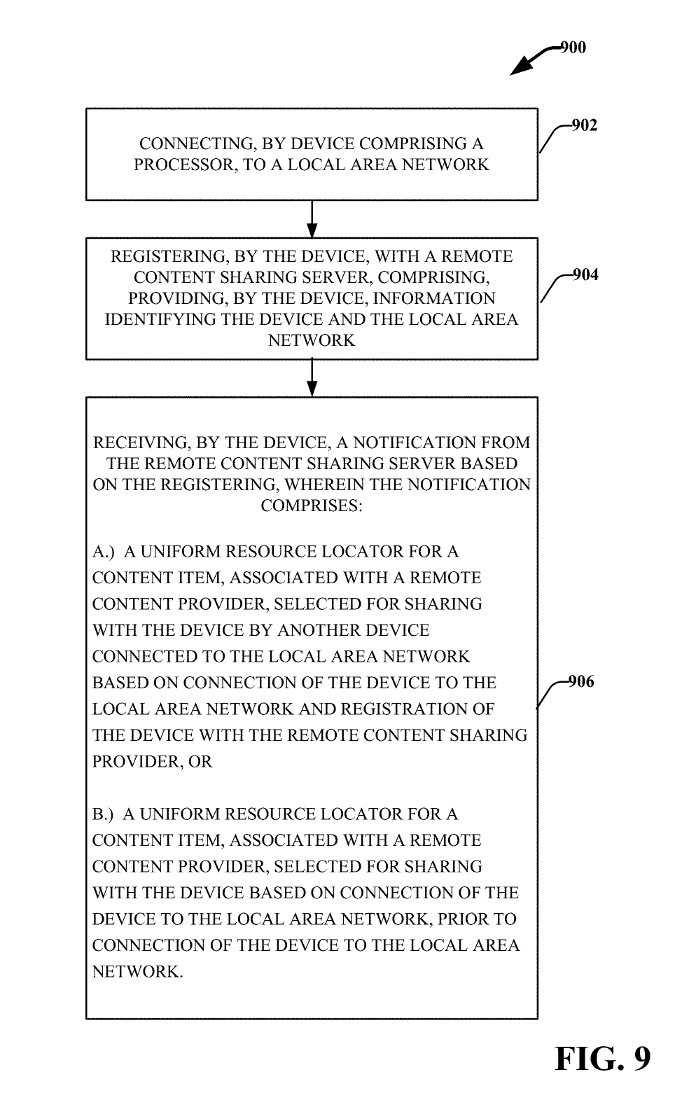

FIG. 9 illustrates a flow chart of another example method 900 for sharing data links with devices based on connection of the devices to a same local network in accordance with aspects described herein. At 902, a device connects to a local area network (e.g., using connection component 210). At 904, the device registers with a remote content sharing server (e.g., using registration component 206) by sending the remote content sharing server information identifying the device and the local area network. Then at 906, the device receives a notification from the remote content sharing server based on the registering (e.g., via notification component 208). In an aspect, the notification includes. A uniform resource locator for a content item, associated with a remote content provider, selected for sharing with the device by another device connected to the local area network based on connection of the device to the local area network and registration of the device with the remote content sharing provider. In another aspect, the notification includes a uniform resource locator for a content item, associated with a remote content provider, selected for sharing with the device based on connection of the device to the local area network, prior to connection of the device to the local area network.

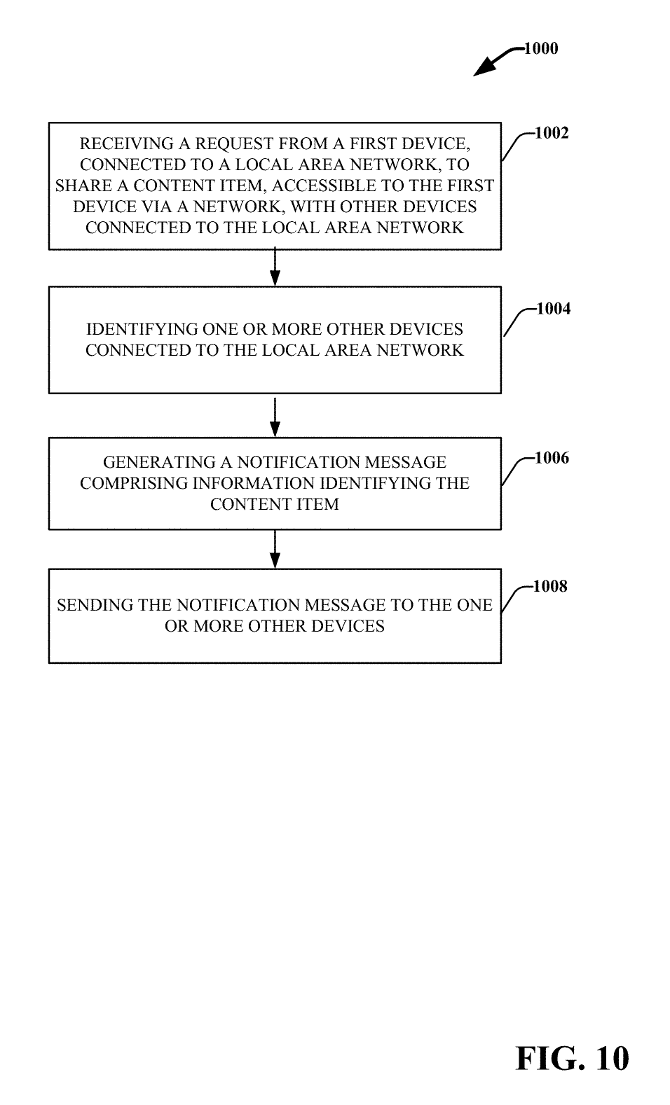

FIG. 10 illustrates a flow chart of another example method 1000 for sharing data links with devices based on connection of the devices to a same local network in accordance with aspects described herein. At 1002, a request is received from a first device, connected to a local area network, to share a content item accessible to the first device via a network, with other devices connected to the local area network (e.g., via sharing component 604). At 1004, one or more other devices connected to the local area network are identified (e.g., via identification component 606). At 1006 a notification message is generated that includes information identifying the content item, such as a hyperlink to the content item (e.g., via notification component 608), and at 1008, the notification message is sent to the one or more other devices (e.g., via notification component 608).

### Example Operating Environments

The systems and processes described below can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders, not all of which may be explicitly illustrated in this disclosure.

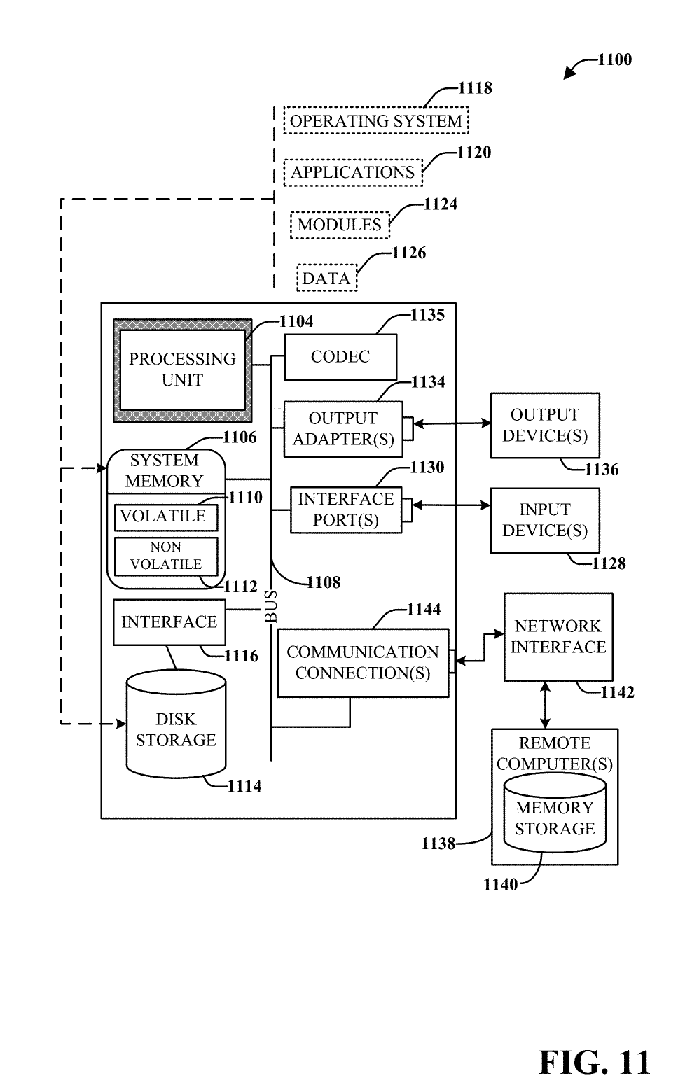

With reference to FIG. 11, a suitable environment 1100 for implementing various aspects of the claimed subject matter includes a computer 1102. The computer 1102 includes a processing unit 1104, a system memory 1106, a codec 1105, and a system bus 1108. The system bus 1108 couples system components including, but not limited to, the system memory 1106 to the processing unit 1104. The processing unit 1104 can be any of various available suitable processors. Dual microprocessors and other multiprocessor architectures also can be employed as the processing unit 1104.

The system bus 1108 can be any of several types of suitable bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 13114), and Small Computer Systems Interface (SCSI).

The system memory 1106 includes volatile memory 1110 and non-volatile memory 1112. The basic input/output system (BIOS), containing the basic routines to transfer information between elements within the computer 1102, such as during start-up, is stored in non-volatile memory 1112. In addition, according to present innovations, codec 1105 may include at least one of an encoder or decoder, wherein the at least one of an encoder or decoder may consist of hardware, a combination of hardware and software, or software. Although, codec 1105 is depicted as a separate component, codec 1105 may be contained within non-volatile memory 1112. By way of illustration, and not limitation, non-volatile memory 1112 can include read only memory (ROM), programmable ROM (PROM), electrically programmable ROM (EPROM), electrically erasable programmable ROM (EEPROM), or flash memory. Volatile memory 1110 includes random access memory (RAM), which acts as external cache memory. According to present aspects, the volatile memory may store the write operation retry logic (not shown in FIG. 11) and the like. By way of illustration and not limitation, RAM is available in many forms such as static RAM (SRAM), dynamic RAM (DRAM), synchronous DRAM (SDRAM), double data rate SDRAM (DDR SDRAM), and enhanced SDRAM (ESDRAM.

Computer 1102 may also include removable/non-removable, volatile/non-volatile computer storage medium. FIG. 11 illustrates, for example, disk storage 1114. Disk storage 1114 includes, but is not limited to, devices like a magnetic disk drive, solid state disk (SSD) floppy disk drive, tape drive, Jaz drive, Zip drive, LS-70 drive, flash memory card, or memory stick. In addition, disk storage 1114 can include storage medium separately or in combination with other storage medium including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1114 to the system bus 1108, a removable or non-removable interface is typically used, such as interface 1116.

It is to be appreciated that FIG. 11 describes software that acts as an intermediary between users and the basic computer resources described in the suitable operating environment 1100. Such software includes an operating system 1118. Operating system 1118, which can be stored on disk storage 1114, acts to control and allocate resources of the computer system 1102. Applications 1120 take advantage of the management of resources by operating system 1118 through program modules 1124, and program data 1126, such as the boot/shutdown transaction table and the like, stored either in system memory 1106 or on disk storage 1114. It is to be appreciated that the claimed subject matter can be implemented with various operating systems or combinations of operating systems.

A user enters commands or information into the computer 1102 through input device(s) 1128. Input devices 1128 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1104 through the system bus 1108 via interface port(s) 1130. Interface port(s) 1130 include, for example, a serial port, a parallel port, a game port, and a universal serial bus (USB). Output device(s) 1136 use some of the same type of ports as input device(s). Thus, for example, a USB port may be used to provide input to computer 1102, and to output information from computer 1102 to an output device 1136. Output adapter 1134 is provided to illustrate that there are some output devices 1136 like monitors, speakers, and printers, among other output devices 1136, which require special adapters. The output adapters 1134 include, by way of illustration and not limitation, video and sound cards that provide a means of connection between the output device 1136 and the system bus 1108. It should be noted that other devices and/or systems of devices provide both input and output capabilities such as remote computer(s) 1138.

Computer 1102 can operate in a networked environment using logical connections to one or more remote computers, such as remote computer(s) 1138. The remote computer(s) 1138 can be a personal computer, a server, a router, a network PC, a workstation, a microprocessor based appliance, a peer device, a smart phone, a tablet, or other network node, and typically includes many of the elements described relative to computer 1102. For purposes of brevity, only a memory storage device 1140 is illustrated with remote computer(s) 1138. Remote computer(s) 1138 is logically connected to computer 1102 through a network interface 1142 and then connected via communication connection(s) 1144. Network interface 1142 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1144 refers to the hardware/software employed to connect the network interface 1142 to the bus 1108. While communication connection 1144 is shown for illustrative clarity inside computer 1102, it can also be external to computer 1102. The hardware/software necessary for connection to the network interface 1142 includes, for exemplary purposes only, internal and external technologies such as, modems including regular telephone grade modems, cable modems and DSL modems, ISDN adapters, and wired and wireless Ethernet cards, hubs, and routers.

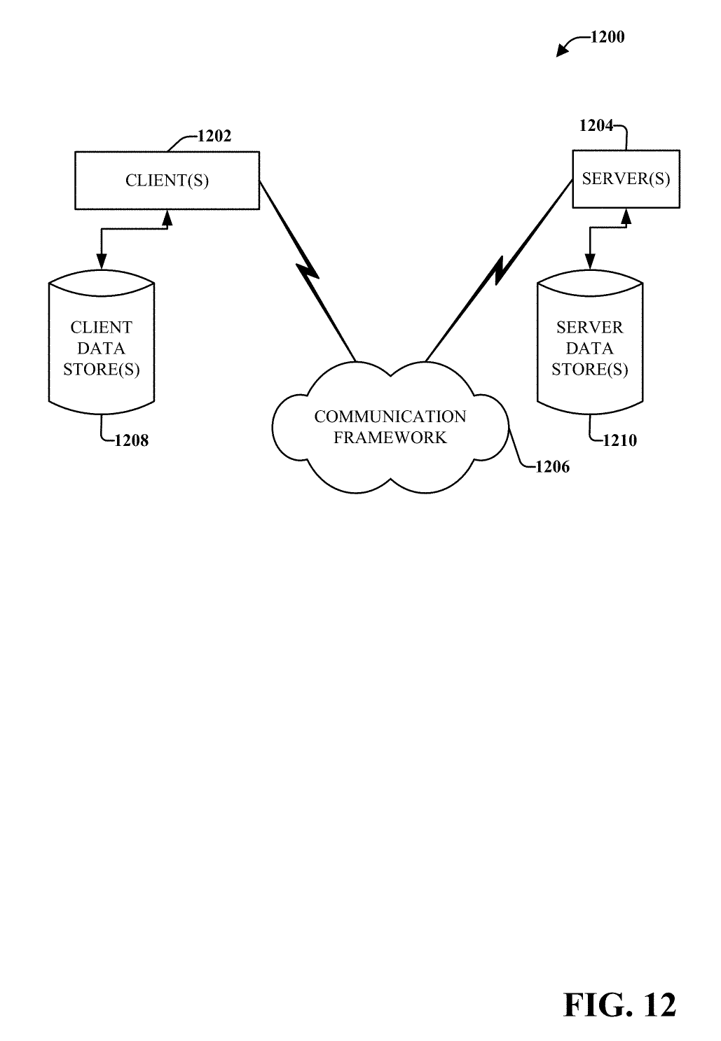

Referring now to FIG. 12, there is illustrated a schematic block diagram of a computing environment 1200 in accordance with this disclosure. The system 1200 includes one or more client(s) 1202 (e.g., laptops, smart phones, PDAs, media players, computers, portable electronic devices, tablets, and the like). The client(s) 1202 can be hardware and/or software (e.g., threads, processes, computing devices). The system 1200 also includes one or more server(s) 1204. The server(s) 1204 can also be hardware or hardware in combination with software (e.g., threads, processes, computing devices). The servers 1204 can house threads to perform transformations by employing aspects of this disclosure, for example. One possible communication between a client 1202 and a server 1204 can be in the form of a data packet transmitted between two or more computer processes wherein the data packet may include video data. The data packet can include a metadata, e.g., associated contextual information, for example. The system 1200 includes a communication framework 1206 (e.g., a global communication network such as the Internet, or mobile network(s)) that can be employed to facilitate communications between the client(s) 1202 and the server(s) 1204.

Communications can be facilitated via a wired (including optical fiber) and/or wireless technology. The client(s) 1202 include or are operatively connected to one or more client data store(s) 1208 that can be employed to store information local to the client(s) 1202 (e.g., associated contextual information). Similarly, the server(s) 1204 are operatively include or are operatively connected to one or more server data store(s) 1210 that can be employed to store information local to the servers 1204.

In one embodiment, a client 1202 can transfer an encoded file, in accordance with the disclosed subject matter, to server 1204. Server 1204 can store the file, decode the file, or transmit the file to another client 1202. It is to be appreciated, that a client 1202 can also transfer uncompressed file to a server 1204 and server 1204 can compress the file in accordance with the disclosed subject matter. Likewise, server 1204 can encode video information and transmit the information via communication framework 1206 to one or more clients 1202.

The illustrated aspects of the disclosure may also be practiced in distributed computing environments where certain tasks are performed by remote processing devices that are linked through a communications network. In a distributed computing environment, program modules can be located in both local and remote memory storage devices.

Moreover, it is to be appreciated that various components described in this description can include electrical circuit(s) that can include components and circuitry elements of suitable value in order to implement the embodiments of the subject innovation(s). Furthermore, it can be appreciated that many of the various components can be implemented on one or more integrated circuit (IC) chips. For example, in one embodiment, a set of components can be implemented in a single IC chip. In other embodiments, one or more of respective components are fabricated or implemented on separate IC chips.

What has been described above includes examples of the embodiments of the present invention. It is, of course, not possible to describe every conceivable combination of components or methodologies for purposes of describing the claimed subject matter, but it is to be appreciated that many further combinations and permutations of the subject innovation are possible. Accordingly, the claimed subject matter is intended to embrace all such alterations, modifications, and variations that fall within the spirit and scope of the appended claims. Moreover, the above description of illustrated embodiments of the subject disclosure, including what is described in the Abstract, is not intended to be exhaustive or to limit the disclosed embodiments to the precise forms disclosed. While specific embodiments and examples are described in this disclosure for illustrative purposes, various modifications are possible that are considered within the scope of such embodiments and examples, as those skilled in the relevant art can recognize.

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the disclosure illustrated exemplary aspects of the claimed subject matter. In this regard, it will also be recognized that the innovation includes a system as well as a computer-readable storage medium having computer-executable instructions for performing the acts and/or events of the various methods of the claimed subject matter.

The aforementioned systems/circuits/modules have been described with respect to interaction between several components/blocks. It can be appreciated that such systems/circuits and components/blocks can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described in this disclosure may also interact with one or more other components not specifically described in this disclosure but known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

As used in this application, the terms “component,” “module,” “system,” or the like are generally intended to refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers. Further, a “device” can come in the form of specially designed hardware; generalized hardware made specialized by the execution of software thereon that enables the hardware to perform specific function; software stored on a computer readable storage medium; software transmitted on a computer readable transmission medium; or a combination thereof.

Moreover, the words “example” or “exemplary” are used in this disclosure to mean serving as an example, instance, or illustration. Any aspect or design described in this disclosure as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Computing devices typically include a variety of media, which can include computer-readable storage media and/or communications media, in which these two terms are used in this description differently from one another as follows. Computer-readable storage media can be any available storage media that can be accessed by the computer, is typically of a non-transitory nature, and can include both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

On the other hand, communications media typically embody computer-readable instructions, data structures, program modules or other structured or unstructured data in a data signal that can be transitory such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

In view of the exemplary systems described above, methodologies that may be implemented in accordance with the described subject matter will be better appreciated with reference to the flowcharts of the various figures. For simplicity of explanation, the methodologies are depicted and described as a series of acts. However, acts in accordance with this disclosure can occur in various orders and/or concurrently, and with other acts not presented and described in this disclosure. Furthermore, not all illustrated acts may be required to implement the methodologies in accordance with certain aspects of this disclosure. In addition, those skilled in the art will understand and appreciate that the methodologies could alternatively be represented as a series of interrelated states via a state diagram or events. Additionally, it should be appreciated that the methodologies disclosed in this disclosure are capable of being stored on an article of manufacture to facilitate transporting and transferring such methodologies to computing devices. The term article of manufacture, as used in this disclosure, is intended to encompass a computer program accessible from a computer-readable device or storage media.

1-11. (canceled)

12. A system, comprising:
one or more memory devices; and
a processor that, when executing the computer executable-instructions stored on the one or more memory devices, is configured to:
detect that each of a plurality of devices are connected to a local area network;
receive, from the plurality of devices connected to the local area network, a registration request that causes notifications to be transmitted to each of the plurality of devices;
register each of the plurality of devices in response to receiving the registration requests;
in response to detecting that the plurality of devices are connected to the same local area network and in response to registering each of the plurality of devices, transmit notifications to each of the plurality of devices that continue to be connected to the local area network, wherein the notifications include content item links shared by one or more of the plurality of devices that are registered and that continue to be connected to the local area network;
determine that a first device of the plurality of devices is associated with a user account of a social network, wherein the user account has a plurality of social contacts on the social network;
receive a request corresponding to a selection of a sharing option from the first device of the plurality of devices, which is connected to the local area network, to share a first content item accessible to the first device via a website over a network, with a subset of other devices, of the plurality of devices, that continue to be connected to the local area network, wherein the subset of other devices are each associated with a social contact of the plurality of social contacts on the social network and have each been registered with the system, and wherein the request includes information identifying the local area network and information identifying the first media content item;
in response to receiving the request corresponding to a selection of the sharing option, determine, based on the information identifying the local area network, the subset of other devices that continue to be connected to the local area network, that have each been registered with the system, and that are each associated with a social contact of the plurality of social contacts on the social network;
generate a notification message comprising a link to the first content item and send the notification message to the subset of other devices, wherein the notification message is sent to a second device from the subset of other devices in response to determining that the second device is connected to the local area network, has been registered with the system, and is associated with a social contact of the plurality of social contacts on the social network, wherein the notification message includes a tag indicating that the first content item is being shared with the second device in response to the determination that the first device and the second device are both connected to the local area network; and
inhibit the link to the first content item from being shared with a third device from the other devices in response to determining that the third device is not associated with a social contact from the plurality of social contacts on the social network.

13. The system of claim 12, wherein the link to the first content item includes a uniform resource locator for the first content item.

14. The system of claim 12, wherein the processor is further configured to determine the other devices connected to the local area network using information provided in a data store associating the other devices with connection to the local area network at the time the request is received.

15. The system of claim 14, wherein the processor is further configured to:
receive the information from one or more of the other devices respectively and cause the information to be provided in the data store.

16. The system of claim 15, wherein the processor is further configured to receive the information from one or more of the other devices, respectively, in response to connection of one or more of the other devices, respectively, to the local area network.

17. The system of claim 15, wherein the processor is further configured to receive the information from one or more of the other devices, respectively, in response to receiving authorization information from the one or more of the other devices, respectively, authorizing the system to register the respective one or more of the other devices.

18. A method comprising:
connecting, by a device including a processor, to a local area network;
registering, by the device that is connected to the local area network, with a remote content sharing server, wherein the registration of the device with the remote content sharing server causes notifications from the remote content sharing server to be transmitted to the device, wherein the device is associated with a user account of a social network, and wherein the user account has a plurality of social contacts on the social network;
in response to connecting the device to the local area network in which other devices have also connected and in response to registering the device with the remote content sharing server in which the other devices have also registered, receiving notifications from the remote content sharing server that include content item links shared by one or more of the other devices registered with the same remote content sharing server and connected to the same local area network as the device;
accessing a website that includes a plurality of content items that are each associated with one or more remote content providers;
in response to receiving a selection of a first content item of the plurality of content items, presenting, using a program associated with the remote content sharing server, a sharing option to share the first content item with a subset of the other devices that continue to be connected to the same local area network and, wherein the subset of other devices are each associated with a social contact of the plurality of social contacts on the social network and are registered with the same remote content sharing server;
receiving a selection of the sharing option;
in response to receiving the selection of the sharing option, transmitting a request to the remote sharing server that includes information identifying the local area network and information identifying the first media content item, wherein the transmitted request is configured to cause the remote sharing server to determine the subset of the other devices to share the content item by filtering the other devices that continue to be connected to the same local area network that are registered with the remote content sharing server, and that are associated with a social contact of the plurality of social contacts on the social network and configured to cause the remote sharing server to transmit to the determined subset of the other devices, wherein a notification from the remote content sharing server including the link to the content item is sent to the subset of the other devices based on the other devices being connected to the local area network, based on the registering with the remote content sharing server and is associated with a social contact of the plurality of social contacts on the social network, wherein the notification of the first content item is presented in connection with a tag indicating that the first content item is being shared with the subset of the other devices in response to the determination that the device and the subset of the other devices are each connected to the local area network, and that cause the remote content sharing server to inhibit the link to the first content item from being shared with a third device from the other devices in response to determining that the third device is not associated with a social contact from the plurality of social contacts on the social network.

19. The method of claim 18, wherein the notification comprises an interactive authorization prompt, wherein the registering further comprises:
sending, by the device in response to selection of an authorization option of the interactive authorization prompt, information authorizing the remote content sharing server to send the device notifications based on connection to the local area network.

20. The method of claim 18, wherein the notification comprises a uniform resource locator for the content item associated with the remote content provider selected for sharing with the device by another device connected to the local area network based on connection of the device to the local area network and registration of the device with the remote content sharing provider.

21. The method of claim 18, wherein the notification comprises a uniform resource locator for the content item associated with the remote content provider selected for sharing with the device based on connection of the device to the local area network, prior to connection of the device to the local area network.
